(19) United States
(12) Patent Application Publication
(10) Pub. No.: US 2026/0017703 A1
(43) Pub. Date: Jan. 15, 2026

(54) Personalized Ranking of Search Query Results Using Engagement-Independent Machine Learning Model for Cold-Start Items

(71) Applicant: Maplebear Inc., San Francisco, CA (US)

(72) Inventors: Prakash Putta, Seattle, WA (US); Vinesh Reddy Gudla, South San Francisco, CA (US); Xiao Xiao, San Diego, CA (US)

(21) Appl. No.: 18/769,202

(22) Filed: Jul. 10, 2024

(51) Int. Cl. G06Q 30/0601

(52) U.S. Cl. CPC G06Q 30/0631

(57) ABSTRACT

An online system receives a query from a user of the online system. The online system identifies a candidate set of cold start results to the query defined as having been presented to the user less than a threshold number of times. The cold start results are then filtered based on their relevance to the query to generate a final set of cold start results and a score is generated for each cold start result without interaction data using a scoring baseline common to standard results with interaction data. Accordingly, the online system ranks the cold start results with a set of standard results based on the score for each cold start result using the scoring baseline and presents the same for display to the user.

### BACKGROUND

The challenge of providing relevant results or recommendations for new or previously unseen queries or items is known as the cold-start problem. This problem often arises when a search engine or recommendation system lacks sufficient data or information about these new items or queries to make accurate predictions or suggestions.

### SUMMARY

An online system receives a query from a user of the online system. The online system identifies a candidate set of cold start results to the query, where the results may include items with which the user can interact using the online system. In one or more embodiments, the candidate set of cold start results are identified as having been presented to the user less than a threshold number of times in a previous time period. Thus, these items are new to the user, new to the particular retailer or the online system, or altogether new, and as such there is relatively little or no information about previous user interactions or engagement with the results. In one or more embodiments, a candidate cold start result is further defined as having received no interaction from the user within the previous time period.

The online system eliminates irrelevant items by filtering the candidate set of cold start results based on their relevance to the query to generate a final set of cold start results. In one or more embodiments, relevant results may be determined using a combination of relevance features, such as an embedding score (e.g., a query-product affinity, determined from a dot product or cosine similarity function applied to the query and product embeddings), text match score, and/or zeroth pass ranking score (or any other coarse-grained ranking score).

The candidate results may initially not be ranked high for the user relative to standard results (i.e., those results with interaction histories) since the candidate results are not associated with any interaction data (e.g., do not have prior order history for the user or even across all users for completely new items). Accordingly, in one or more embodiments, a score is determined for each cold start result using a scoring baseline common to standard results with interaction data. The score is determined such that it does not disadvantage the cold start results relative to the standard results while determining the score without interaction data. The scoring baseline common to both cold start results without interaction data and standard results with interaction data can be determined using different methods. In one or more embodiments, the score is a probability of conversion (pCVR) score calculated for the cold start results without interaction data to enable comparison of the cold start results to standard results whose probability of conversion scores use interaction data in the calculation.

The online system, in one or more embodiments, trains a conversion prediction model that does not use as input features any user interaction data. The conversion prediction model predicts a probability of conversion for each candidate cold start result and uses the model output as a baseline score for ranking the candidate results relative to the standard results. Since the model does not use user interaction data as an input, the new results or items are not disadvantaged relative to standard results or items with more extensive interaction histories.

The scoring baseline common to both cold start results without interaction data and standard results with interaction data, in other embodiments, can be a combination of a user embedding dot product score and a query product embedding dot product score. In this example, the online system is an online concierge system and each of the cold start results and the standard results correspond to an item available for purchase through a multi-retailer marketplace.

Accordingly, the online system ranks the cold start results with a set of standard results based on the score for each cold start result using the scoring baseline and presents the same for display to the user.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a block diagram illustrating one or more embodiments of a content presentation module for an online system.

FIG. 4 is a flowchart illustrating one or more embodiments of a user-level process for cold start search result identification and ranking.

FIG. 5 illustrates an example ordering interface presenting cold start results alongside standard results, in accordance with one or more embodiments.

### DETAILED DESCRIPTION

### Overview

In personalized online search systems, where the search results are ranked based on a user engagement, items for which users have little or no interaction data (e.g., views, purchases, etc.) are much less likely to appear in the search results (i.e., a “cold start” problem). This issue is of particular relevance in grocery ecommerce where repeat purchases are a far more common occurrence relative to regular ecommerce – even in search, greater than 20% of search conversions occur for “buy it again” items, which are items that were previously purchased by the user.

Prior approaches have attempted to solve this problem at an item-level while the present disclosure solves this problem at a user-level. In various embodiments, item-level cold-start refers to the traditional cold-start problem where an item that has not been displayed or engaged with previously needs to be ranked or recommended. The number of items an item was displayed or engaged with may be determined by aggregating this data across all the users on the platform for each item. On the other hand, user-level cold-start may be a generalization of this that looks at the engagement specific to each user without the aggregation (i.e., any product that a user has not seen or engaged with may be considered to be part of the user cold-start candidate set).

Additionally, given the multi-retailer marketplace where users are generally loyal to a retailer, the disclosed method can be applied to transfer knowledge across different retailers. Specifically, the disclosed method can be used to transfer buy it again knowledge across retailers to better rank potentially similar or ideal replacement items at a different retailer for which the system does not have prior interaction data for a user.

To address this cold start problem, the online system identifies search results for which there is little or no interaction data. These results could be new to the user, new to the particular retailer or the online system, or altogether new. The cold start results are then filtered based on their relevance to the query to generate a final set of cold start results using an embedding score, text match score, zeroth pass ranking score, and so forth. The system then determines a score for each cold start result without using interaction data in the calculation using a scoring baseline common to standard results with interaction data. Using conventional approaches, the cold start results would not be ranked highly for the user since they are not associated with interaction data (e.g., no prior order or other interaction data, etc.). Thus, scoring results where interaction data (or the lack thereof) is omitted from the calculation is unconventional. Accordingly, in one or more embodiments, the system uses a selection model trained on input features that do not include historical interaction data. The selection model, in one or more embodiments, predicts the probability of conversion (pCVR) for each candidate cold start result and uses the model output as a baseline score for ranking the candidate results relative to standard results. Since this model does not use user interaction data as an input, the new results or items are not disadvantaged relative to the standard results with more extensive interaction histories. The probability of conversion for the cold start results, since it is determined without interaction data, is not necessarily an accurate measure of conversion; however, it enables a relative ranking of the cold start results with the standard results. In one or more embodiments, the selection model used to predict conversion of the candidate cold start results (without interaction data) is different from a model used to predict the probability of conversion for standard results (with interaction data). The cold start and standard results are then combined and ranked together into a single ranking.

In one or more embodiments, the online system is an online concierge system and each of the cold start results and the standard results correspond to an item or product available for purchase by the user through a multi-retailer marketplace. Accordingly, the scoring baseline for the cold start results can be a combination of a user embedding dot product score and a query product embedding dot product score. In this example, the user embedding dot product score and a query product embedding dot product score do not incorporate interaction data into the dot product score and this combination is compatible with the dot product scores of standard results to enable a non-biased relative ranking of cold start items and those items with interaction histories. Different scoring methodologies can be employed to arrive at a scoring baseline common to both cold start results without interaction data and standard results with interaction data.

The system then ranks and selects a subset of those items and presents them in a user interface for the user.

### Online System

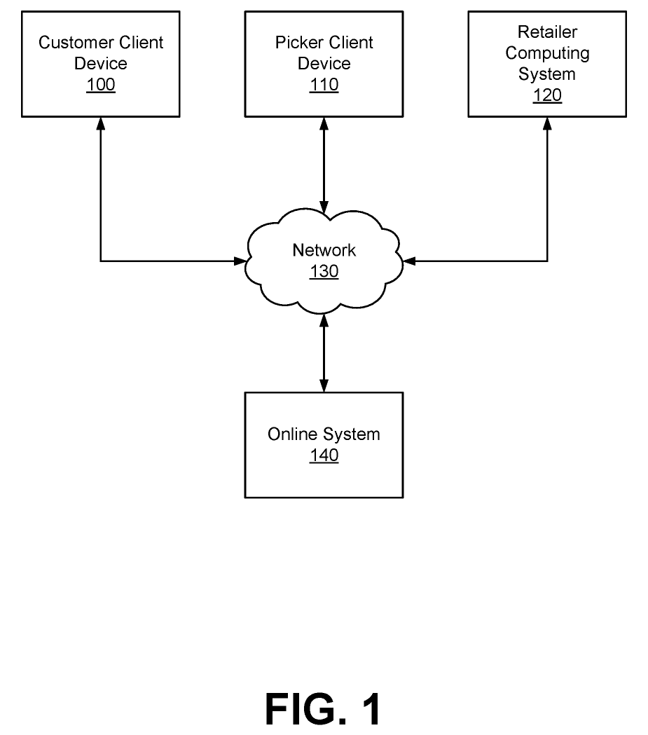

FIG. 1 illustrates an example system environment for an online system 140, in accordance with one or more embodiments. The system environment illustrated in FIG. 1 includes a user client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online system 140. As such, there may be more than one user client device 100, picker client device 110, or retailer computing system 120.

The user client device 100 is a client device through which a user may interact with the picker client device 110, the retailer computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user’s order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a particular retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user’s order (e.g., as a commission).

The user client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a retailer. The online system 140 receives orders from a user client device 100 through the network 130. The online system 140 selects a picker to service the user’s order and transmits the order to a picker client device 110 associated with the picker. The picker collects the ordered items from a retailer location and delivers the ordered items to the user. The online system 140 may charge a user for the order and provide portions of the payment from the user to the picker and the retailer.

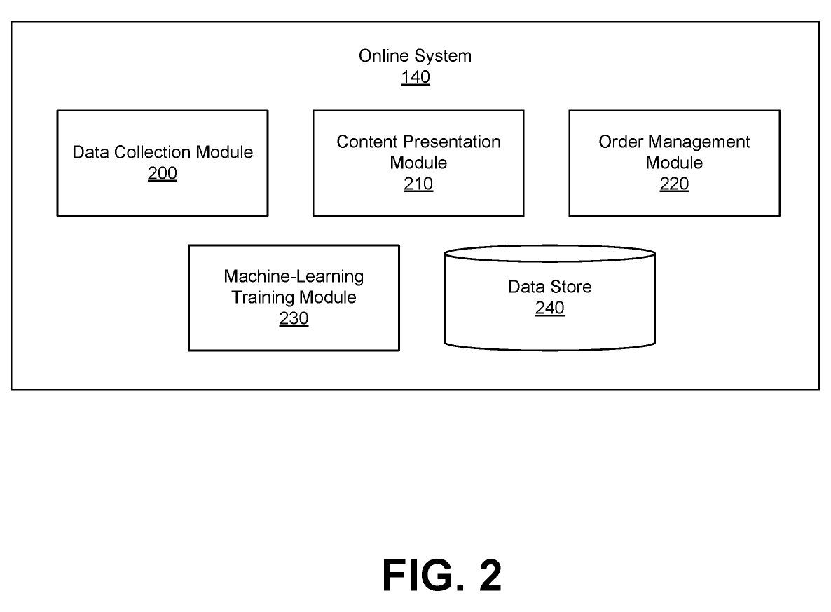

As an example, the online system 140 may allow a user to order groceries from a grocery store retailer. The user’s order may specify which groceries they want delivered from the grocery store and the quantities of each of the groceries. The user’s client device 100 transmits the user’s order to the online system 140 and the online system 140 selects a picker to travel to the grocery store retailer location to collect the groceries ordered by the user. Once the picker has collected the groceries ordered by the user, the picker delivers the groceries to a location transmitted to the picker client device 110 by the online system 140. The online system 140 is described in further detail below with regards to FIG. 2.

### Example Concierge System Architecture

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which retailers the picker has collected items at, or the picker’s previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

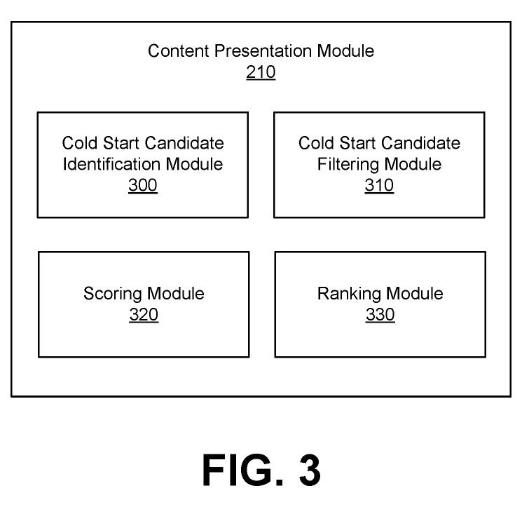

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items). Scoring will be further described with respect to FIG. 3.

FIG. 3 is a block diagram illustrating one or more embodiments of a content presentation module 210 for an online system. The content presentation module 210 comprises a cold start candidate identification module 300, a cold start candidate filtering module 310, a scoring module 320, and a ranking module 330. In other embodiments, the content presentation module 210 may comprise different or additional modules, such as modules for identifying and filtering standard candidates (i.e., non-cold start candidates).

The cold start candidate identification module 300 identifies a candidate set of cold start results in response to a query received by the online system from a user. In one or more embodiments, cold start candidate identification module 300 identifies items that have been presented to the user less than a threshold number of times in a previous time period. Items falling under the user level cold start category are defined as those that have been presented to a user fewer than x times in the last 90 days, with no interaction from the user within this period. In one example, x equals 5 impressions, but can be any number (e.g., 1-20). This approach applies across retailers since the system uses user level data. Accordingly, these are items that are either new to the user, new to the online system, or new to the world.

In one or more embodiments, in addition to the above approach of identifying candidates that have been presented to the user less than a threshold number of times, cold start candidate identification module 300 may use the previous purchase history of a user to identify similar items in their purchase history in retailers they have not yet visited to identify one or more candidate items for which the use may have an affinity.

The cold start candidate filtering module 310 filters the candidate set of cold start results based on relevance to the query to generate a final set of cold start results. After identifying the initial candidates, the cold start candidate filtering module 310 eliminates irrelevant items based on the query to generate the final set. In one or more embodiments, relevant results may be determined using a combination of relevance features, such as an embedding score, text match score, and/or zeroth pass ranking score.

The scoring module 320, in one or more embodiments, may use one or more item selection models to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in data store 240.

The scoring module 320, in one or more embodiments, determines a score for each cold start result of the final set of cold start results using a scoring baseline in common with standard results to enable a relative ranking. The scoring module 320 determines the scores without interaction data and the scoring baseline enables comparison of cold start results without interaction data to the standard results with interaction data. In one or more embodiments, the score is a prediction of user engagement (i.e., engagement prediction) that includes views, clicks, saving an item to a wish or shopping list, and purchases.

In one or more embodiments, the selection model is a probability of conversion (pCVR) model and the scoring module 320 trains the model without user interaction data that, when applied to a set of candidate cold start results, predicts the probability of conversion for each candidate. Since the model does not use user interaction data as an input, the new results or items are not disadvantaged relative to results or items with more extensive interaction histories. In various embodiments, the scoring module 320 trains the conversion prediction model using the inputs of past interaction events (e.g., clicks, purchases, etc.) at the user-retailer level, retailer features (e.g., retailer type, retailer purchase distribution, etc.), user features (e.g., user purchase history, user embeddings, etc.), product features (e.g., product embeddings, product metadata, etc.) and trains the model to output the probability of conversion for an item for a given user.

The scoring module 320, in one or more embodiments, uses a different selection model to determine the probability of conversion for standard results (i.e., those results with interaction histories) that uses prior interaction data as an input to the model. In alternative embodiments, the scoring module 320 uses the same selection model to determine the probability of conversion for cold start results (i.e., those without interaction data) and standard results (i.e., those results with interaction histories) using the above-described inputs to the model. In one or more embodiments, the same selection model can be used to determine the probability of conversion for both cold start results and standard results where the interaction data associated with the standard results is not used in the probability of conversion determination to enable a relative ranking of cold start and standard results. Additionally, in one or more embodiments, the item selection model uses a combination of a user embedding dot product score and a query product embedding dot product score.

The scoring module 320, in other embodiments, may score items based on a search query received from the user client device 100. A search query is free text for a word or set of words that indicate items of interest to the user. The scoring module 320 scores items based on a relatedness of the items to the search query. For example, the scoring module 320 may apply natural language processing (NLP) techniques to the text in the search query to generate a search query representation (e.g., an embedding) that represents characteristics of the search query. The scoring module 320 may use the search query representation to score candidate items for presentation to a user (e.g., by comparing a search query embedding to an item embedding).

Additionally, the scoring module 320, in other embodiments, may score items based on a predicted availability of an item. The scoring module 320 may use an availability model to predict the availability of an item. An availability model is a machine-learning model that is trained to predict the availability of an item at a particular retailer location. For example, the availability model may be trained to predict the likelihood that an item is available at a retailer location or may predict an estimated number of items that are available at a retailer location. The scoring module 320 may apply a weight to the score for an item based on the predicted availability of the item. Alternatively, the scoring module 320 may filter out items from presentation to a user based on whether the predicted availability of the item exceeds a threshold.

Ranking module 330 ranks the final set of cold start results with a set of standard results based on the score for each cold start result using the scoring baseline. Accordingly, the content presentation module 210 scores and ranks the items based on their scores. The content presentation module 210 causes the items with scores that exceed some threshold (e.g., the top n items or the p percentile of items) to be presented to the user.

Referring to FIG. 2, the order management module 220 manages orders for items from users. Order management module 220 receives orders from a user client device 100 and assigns the orders to pickers for service based on picker data. For example, the order management module 220 assigns an order to a picker based on the picker’s location and the location of the retailer from which the ordered items are to be collected. The order management module 220 may also assign an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. Order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker’s current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

Order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online system 140. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. Data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

### Method for Cold Start Search Result Identification and Ranking

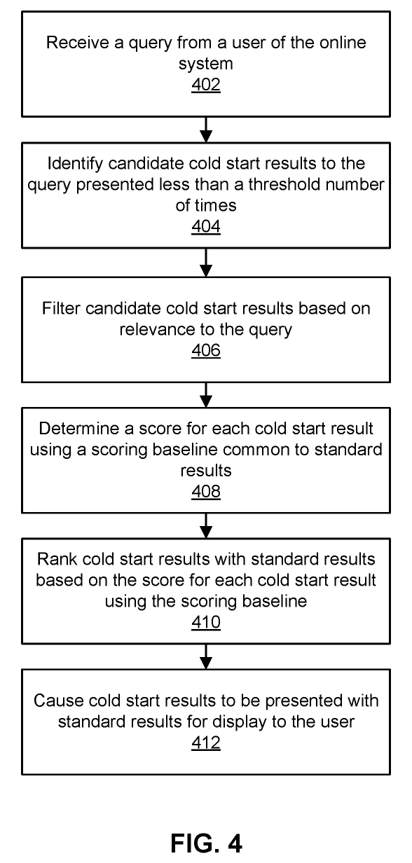

FIG. 4 is a flowchart for a user-level based method for identifying and ranking cold start search results, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 receives 402 a query from a user of the online system 140 via the user client device 100. In one or more embodiments, the user can search for items provided by the online system 140 via one or more queries using user client device 100.

In response to the query, cold start candidate identification module 300 identifies 404 a candidate set of cold start results to the query that have been presented to the user less than a threshold number of times in a previous time period (e.g., last 90 days, etc.). Accordingly, these results could be new to the user, new to the particular retailer or the online system, or altogether new.

Cold start candidate filtering module 310 filters 406 the candidate set of cold start results based on relevance to the query to generate a final set of cold start results. After identifying the initial candidates, the cold start candidate filtering module 310 eliminates irrelevant items based on the query to generate the final set. In one or more embodiments, relevant results may be determined using a combination of relevance features, such as an embedding score, text match score, and/or zeroth pass ranking score.

Scoring module 320 determines 408 a score for each cold start result of the final set of cold start results using a scoring baseline common to standard results to enable a comparison of results without interaction data to results with interaction data. Thus, the score for each of the final sets of cold start results is determined without using interaction data (or lack thereof) for the cold start results. Using conventional approaches, the absence of interaction data (e.g., no prior order or other interaction data, etc.) would, in general, cause the cold start results to be ranked much lower relative to standard results with interaction data.

Ranking module 330 ranks 410 the final set of cold start results with a set of standard results based on the score for each cold start result using the scoring baseline. In one or more embodiments, the ranking is based on a probability of conversion value or score for each cold start and standard result.

Content presentation module 210 causes 412 at least a subset of the final set of cold start results to be presented with at least a subset of the set of standard results for display to the user on the computing device of the user. In one or more embodiments, the content presentation module 210 causes the items with scores that exceed some threshold (e.g., the top n items or the p percentile of items) to be presented to the user.

Accordingly, in one or more embodiments, scoring module 320 uses a selection model to determine the score for each cold start result and the selection model is trained on input features that do not include historical interaction data. The selection model predicts the probability of conversion for each cold start result and uses the model output as a baseline score for ranking the candidate results. Since the model does not use user interaction data as an input, the new results or items are not disadvantaged relative to results associated with more extensive interaction histories. In one or more embodiments, the selection model used to predict conversion of the candidate cold start results (without interaction data) is different from a model used to predict the probability of conversion for standard results (with interaction data). The results are then combined and ranked together into a single ranking.

In one or more embodiments, the conversion prediction model is trained by obtaining user characteristics, user interaction history (e.g., viewing history, purchase history, etc.) for a set of users in a training population, product or item characteristics, and retailer characteristics and training the machine learning model without interaction data to learn model parameters indicative of causal relationships between purchases and the user characteristics and user interaction history for the set of users in the training population dependent on the product characteristics and the retailer characteristics.

In one or more embodiments, the scoring baseline for the cold start results can be a combination of a user embedding dot product score and a query product embedding dot product score. In this example, the user embedding dot product score and a query product embedding dot product score do not incorporate interaction data into the dot product score and this combination is compatible with the dot product scores of standard results to enable a non-biased relative ranking of cold start items and items interaction histories. Different scoring methodologies can be employed to arrive at a scoring baseline common to both cold start results without interaction data and standard results with interaction data. In one or more embodiments, the system collects user input or feedback and uses this information as additional training data to update the model.

### User Interfaces for Presenting Cold Start Search Results

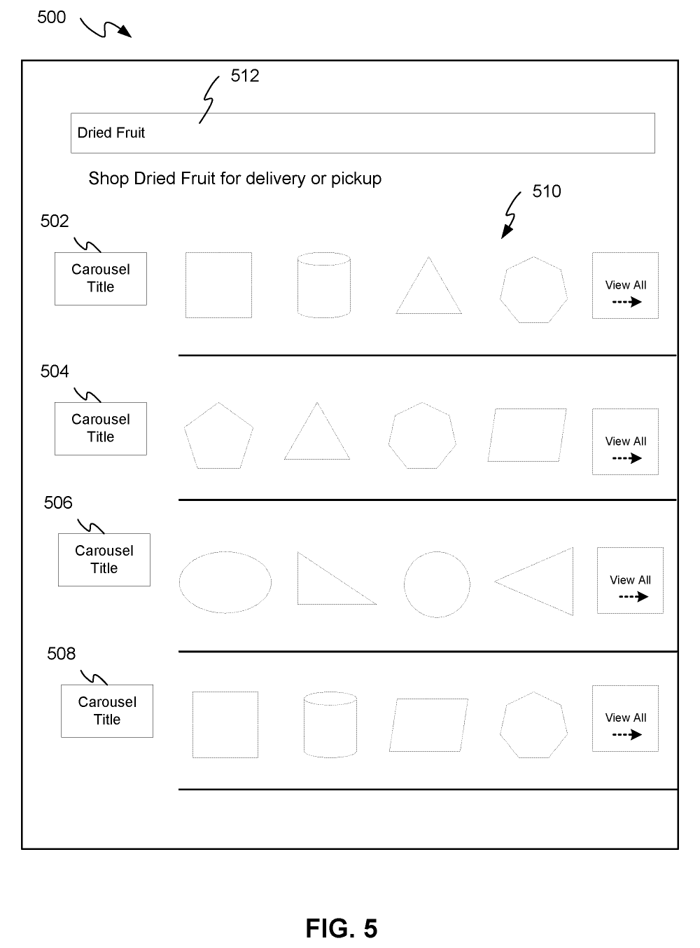

FIG. 5 illustrates an example ordering interface 500 presenting cold start results alongside standard results, in accordance with one or more embodiments. In this example, ordering interface 500 includes text field 512 through which online system 140 receives queries from a user. In response to a query, online system 140 causes results 510 that satisfy the query to be presented to the user in carousels 502, 504, 506, 508. While carousels are shown, results satisfying the query could be presented in a grid and each result in an individual slot. In one example, the carousels 502, 504, 506, 508 correspond to different types of dried fruit for the same retailer, and cold start items are suggested in a single carousel. In another example, carousels 502, 504, 506, 508 correspond to different retailers, and cold start items correspond to a new retailer. A user can scroll items within each carousel 502, 504, 506, 508, and users may select specific items in a carousel (e.g., to add the items to a shopping cart) by clicking on or otherwise selecting one or more items.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, by the computing system of an online system, a query from a user of the online system;
identifying a candidate set of cold start results to the query, the candidate set of cold start results having been presented to the user less than a threshold number of times in a previous time period;
filtering the candidate set of cold start results based on relevance to the query to generate a final set of cold start results;
generating, using a machine learning model, a score for each cold start result of the final set of cold start results using a scoring baseline common to standard results, wherein the score is generated without interaction data, and wherein the scoring baseline enables comparison of cold start results without interaction data to the standard results with interaction data;
ranking the final set of cold start results with a set of standard results based on the score for each cold start result using the scoring baseline; and
causing, responsive to the query, at least a subset of the final set of cold start results to be presented with at least a subset of the set of standard results for display to the user.

2. The method of claim 1, wherein identifying a candidate set of cold start results to the query comprises identifying a set of items available for purchase by the user through a multi-retailer marketplace provided by an online concierge system.

3. The method of claim 1, wherein generating the score for each cold start result of the final set of cold start results using the scoring baseline common to standard results comprises:
applying the machine learning model to the final set of cold start results trained to generate a probability of conversion for each of the set of cold start results without the interaction data, wherein the probability of conversion is the scoring baseline common to the cold start results and the standard results.

4. The method of claim 3, wherein the online system is an online concierge system, each of the cold start results and the standard results correspond to an item available for purchase by the user through a multi-retailer marketplace provided by the online concierge system, and the machine learning model is trained by:
obtaining user characteristics and user interaction history for a set of users in a training population, wherein the interaction history includes viewing history and purchase history;
obtaining product characteristics and retailer characteristics; and
training the machine learning model without interaction data to learn model parameters indicative of causal relationships between purchases and the user characteristics and user interaction history for the set of users in the training population dependent on the product characteristics and the retailer characteristics.

5. The method of claim 3, wherein the machine learning model used to generate the probability of conversion for the cold start results is different from a machine learning model used to generate the probability of conversion for the standard results, the machine learning model used to generate the probability of conversion for the cold start results does not use interaction data in the generation of the probability of conversion for the standard results, and the machine learning model used to generate the probability of conversion for the standard results uses the interaction data in the generation of the probability of conversion for the standard results.

6. The method of claim 1, wherein causing at least a subset of the final set of cold start results to be presented with at least a subset of the set of standard results for display to the user comprises causing at least the subset of the final set of cold start results to be presented with the set of standard results in at least one of a grid or list for display to the user based on the ranking.

7. The method of claim 1, wherein identifying a candidate set of cold start results to the query comprises identifying cold start results that have been presented to the user less than the threshold number of times in the previous time period, and that have received no interaction from the user within the previous time period.

8. The method of claim 7,. the online system is an online concierge system, each of the cold start results and the standard results correspond to an item available for purchase by the user through a multi-retailer marketplace provided by the online concierge system, and wherein at least one of the cold start results is at least one of new to the online concierge system or being offered for purchase by a retailer that is at least one of new to the user or new to the online concierge system.

9. A non-transitory computer-readable storage medium storing instructions executable by one or more processors for performing steps comprising:
receiving a query from a user of an online system;
identifying a candidate set of cold start results to the query, the candidate set of cold start results having been presented to the user less than a threshold number of times in a previous time period;
filtering the candidate set of cold start results based on relevance to the query to generate a final set of cold start results;
generating, using a machine learning model, a score for each cold start result of the final set of cold start results using a scoring baseline common to standard results, wherein the score is generated without interaction data, and wherein the scoring baseline enables comparison of cold start results without interaction data to the standard results with interaction data;
ranking the final set of cold start results with a set of standard results based on the score for each cold start result using the scoring baseline; and
causing, responsive to the query, at least a subset of the final set of cold start results to be presented with at least a subset of the set of standard results for display to the user.

10. The non-transitory computer-readable storage medium of claim 9, wherein identifying a candidate set of cold start results to the query comprises identifying a set of items available for purchase by the user through a multi-retailer marketplace provided by an online concierge system.

11. The non-transitory computer-readable storage medium of claim 9, wherein generating the score for each cold start result of the final set of cold start results using the scoring baseline common to standard results comprises:
applying the machine learning model to the final set of cold start results trained to generate a probability of conversion for each of the set of cold start results without the interaction data, wherein the probability of conversion is the scoring baseline common to the cold start results and the non-cold start results.

12. The non-transitory computer-readable storage medium of claim 11, wherein the online system is an online concierge system, each of the cold start results and the standard results correspond to an item available for purchase by the user through a multi-retailer marketplace provided by the online concierge system, and the machine learning model is trained by:
obtaining user characteristics and user interaction history for a set of users in a training population, wherein the interaction history includes viewing history and purchase history;
obtaining product characteristics and retailer characteristics; and
training the machine learning model without interaction data to learn model parameters indicative of causal relationships between purchases and the user characteristics and user interaction history for the set of users in the training population dependent on the product characteristics and the retailer characteristics.

13. The non-transitory computer-readable storage medium of claim 11, wherein the machine learning model used to generate the probability of conversion for the cold start results is different from a machine learning model used to generate the probability of conversion for the standard results, the machine learning model used to generate the probability of conversion for the cold start results does not use interaction data in the generation of the probability of conversion for the standard results, and the machine learning model used to generate the probability of conversion for the standard results uses the interaction data in the generation of the probability of conversion for the standard results.

14. The non-transitory computer-readable storage medium of claim 9, wherein identifying a candidate set of cold start results to the query comprises identifying cold start results that have been presented to the user less than the threshold number of times in the previous time period, and that have received no interaction from the user within the previous time period.

15. The non-transitory computer-readable storage medium of claim 14,. the online system is an online concierge system, each of the cold start results and the standard results correspond to an item available for purchase by the user through a multi-retailer marketplace provided by the online concierge system, and wherein at least one of the cold start results is at least one of new to the online concierge system or being offered for purchase by a retailer that is at least one of new to the user or new to the online concierge system.

16. A computer system comprising:
one or more processors; and
a non-transitory computer-readable storage medium storing instructions executable by the one or more processors for performing steps including:
receiving a query from a user of an online system;
identifying a candidate set of cold start results to the query, the candidate set of cold start results having been presented to the user less than a threshold number of times in a previous time period;
filtering the candidate set of cold start results based on relevance to the query to generate a final set of cold start results;
generating, using a machine learning model, a score for each cold start result of the final set of cold start results using a scoring baseline common to standard results, wherein the score is generated without interaction data, and wherein the scoring baseline enables comparison of cold start results without interaction data to the standard results with interaction data;
ranking the final set of cold start results with a set of standard results based on the score for each cold start result using the scoring baseline; and
causing, responsive to the query, at least a subset of the final set of cold start results to be presented with at least a subset of the set of standard results for display to the user.

17. The computer system of claim 16, wherein identifying a candidate set of cold start results to the query comprises identifying a set of items available for purchase by the user through a multi-retailer marketplace provided by an online concierge system.

18. The computer system of claim 16, wherein generating the score for each cold start result of the final set of cold start results using the scoring baseline common to standard results comprises:
applying the machine learning model to the final set of cold start results trained to generate a probability of conversion for each of the set of cold start results without the interaction data, wherein the probability of conversion is the scoring baseline common to the cold start results and the non-cold start results.

19. The computer system of claim 18, wherein the online system is an online concierge system, each of the cold start results and the standard results correspond to an item available for purchase by the user through a multi-retailer marketplace provided by the online concierge system, and the machine learning model is trained by:
obtaining user characteristics and user interaction history for a set of users in a training population, wherein the interaction history includes viewing history and purchase history;
obtaining product characteristics and retailer characteristics; and
training the machine learning model without interaction data to learn model parameters indicative of causal relationships between purchases and the user characteristics and user interaction history for the set of users in the training population dependent on the product characteristics and the retailer characteristics.

20. The computer system of claim 18, wherein the machine learning model used to generate the probability of conversion for the cold start results is different from a machine learning model used to generate the probability of conversion for the standard results, the machine learning model used to generate the probability of conversion for the cold start results does not use interaction data in the generation of the probability of conversion for the standard results, and the machine learning model used to generate the probability of conversion for the standard results uses the interaction data in the generation of the probability of conversion for the standard results.
